(19) United States
(12) Patent Application Publication
(10) Pub. No.: US 2026/0343491 A1
(43) Pub. Date: Oct. 29, 2026

(54) METHODS AND APPARATUSES FOR HANDLING CONSISTENT LBT FAILURE

(71) Applicant: LENOVO (BEIJING) LIMITED, Beijing (CN)

(72) Inventors: Jing HAN, Beijing (CN); Lianhai WU, Beijing (CN); Min XU, Beijing (CN); Ran YUE, Beijing (CN); Haiming WANG, Beijing (CN)

(21) Appl. No.: 19/099,171

(22) PCT Filed: Jul. 29, 2022
(86) PCT No.: PCT/CN2022/108893

§ 371 Date: Jan. 28, 2025

(51) Int. Cl. H04W 72/02; H04W 74/0808

(52) U.S. Cl. CPC H04W 72/02; H04W 74/0808

(57) ABSTRACT

The present application relates to methods and apparatuses for handling a consistent listen before talk (LBT) failure. An embodiment of the present disclosure provides a user equipment (UE), which includes: a transceiver; and a processor coupled with the transceiver and configured to: detect a consistent LBT failure on a resource block (RB) set of an SL bandwidth part (BWP); perform one of the following: triggering a resource selection procedure; triggering a resource pool selection procedure; transmitting a first indication indicating the consistent LBT failure on the RB set; determining the RB set as recovered in response to one or more conditions being fulfilled; or triggering a consistent LBT failure for the SL BWP or declare an SL BWP failure.

### TECHNICAL FIELD

The present disclosure relates to wireless transmission, and more particularly to methods and apparatuses for handling a consistent listen before talk (LBT) failure.

### BACKGROUND OF THE INVENTION

In new radio unlicensed (NRU) spectrum, plenty of unlicensed bands or channels can be used for wireless transmission (e.g. WiFi, Bluetooth, 3G, 4G, etc.). An LBT procedure is performed before each transmission to determine whether the unlicensed band or channel is available. If LBT fails, which means the channel has been occupied, an LBT failure indication is sent to the media access control (MAC) entity from lower layers (e.g. a physical (PHY) layer). Then the MAC entity may count the number of LBT failure indication from lower layer in a time period, and trigger a consistent LBT failure when the number of LBT failure indication exceeds a threshold (for example, a preconfigured maximum number within the time period).

Sidelink (SL) is a direct link for communications between devices used for several applications, such as proximity service (Device to Device (D2D)), Vehicle to Vehicle (V2V), Vehicle to Passenger (V2P), Internet of Things (IoT), wearable, etc. SL transmission, which may also be operated on an unlicensed band for public safety or commercial use, is required to perform the similar LBT procedure defined in the NRU as discussed above. However, SL transmission would not be initiated if consistent LBT failure is detected or triggered for a SL-BWP since only one SL-BWP is supported for sidelink. That is, if the LBT failure is counted for the SL-BWP, after a consistent LBT failure is triggered, the whole SL-BWP is regarded as failure and SL transmission cannot be performed. Failure of the SL transmission can jeopardize public safety or commercial interest.

Therefore, instead of trigger a consistent LBT failure for the whole SL-BWP, trigger a consistent LBT failure for a part of SL-BWP, e.g. an RB set is a possible way forward. So it is desirable to provide solutions for handling a per RB set consistent LBT failure in a SL-U system.

### SUMMARY

An embodiment of the present disclosure provides a user equipment (UE), which includes: a transceiver; and a processor coupled with the transceiver and configured to: detect a consistent LBT failure on a resource block (RB) set of an SL bandwidth part (BWP); perform one of the following: triggering a resource selection procedure; triggering a resource pool selection procedure; transmitting a first indication indicating the consistent LBT failure on the RB set; determining the RB set as recovered in response to one or more conditions being fulfilled; or triggering a consistent LBT failure for the SL BWP or declare an SL BWP failure.

In some embodiments, the resource selection procedure includes: performing a resource selection procedure for remaining transmission(s) on an RB set with no consistent LBT failure for a one-shot transmission; performing a resource selection procedure for reserved resource(s) on the RB set with no consistent LBT failure for a multi-shot transmission; or performing a resource selection procedure for remaining transmission(s) on the RB set with no consistent LBT failure, wherein the remaining transmission(s) is associated with at least one of: a specific destination, a specific logical channel (LCH), or an LCH with a specific priority level.

In some embodiments, the resource pool selection procedure includes one of the following: prohibiting selection of a resource pool including the RB set; or selecting the resource pool including the RB set in the case that no other resource pool is available and the resource pool includes other RB sets with no consistent LBT failure.

In some embodiments, the resource pool including the RB set is determined with a lower priority level compared with other resource pool(s) with no consistent LBT failure on any RB set in the other resource pool(s).

In some embodiments, the RB set in the resource pool is determined with a lower priority level compared with other RB set(s) in the resource pool.

In some embodiments, the first indication includes a media access control control element (MAC CE) or a radio resource control (RRC) signalling.

In some embodiments, the one or more conditions include: a prohibit timer being expired; an LBT success number associated with the RB set being higher than a first threshold; an LBT failure number associated with the RB set being lower than a second threshold; a result of a channel busy ratio (CBR) measurement on that RB set being lower than a third threshold; a second indication from the BS indicating that the RB set is recovered; a third indication from the BS indicating that at least one of the RB set, a resource pool of the RB set, or the SL BWP is reconfigured.

In some embodiments, in the case that a consistent LBT failure on each RB set of the SL BWP is detected, the processor is further configured to: trigger a consistent LBT failure for the SL BWP; or declare an SL BWP failure.

In some embodiments, the processor is further configured to: transmit a fourth indication indicating the consistent LBT failure for the SL BWP.

Another embodiment of the present disclosure provides a base station (BS), which includes: a transceiver; and a processor coupled with the transceiver and configured to: receive, from a UE, a first indication indicating a consistent LBT failure on a resource block (RB) set of an SL BWP; and perform one of the following: transmitting, to the UE, a second indication indicating that the RB set is recovered, or a third indication indicating that at least one of the RB set, a resource pool of the RB set, or the SL BWP is reconfigured; or receiving, from the UE, a fourth indication indicating a consistent LBT failure on each RB set of the SL BWP; and indicating another SL BWP to the UE.

In some embodiments, the first indication includes a MAC CE or a radio resource control (RRC) signalling.

Yet another embodiment of the present disclosure provides a method performed by a UE, which includes: detecting a consistent LBT failure on a resource block (RB) set of an SL BWP; performing one of the following: triggering a resource selection procedure; triggering a resource pool selection procedure; transmitting a first indication indicating the consistent LBT failure on the RB set; determining the RB set as recovered in response to one or more conditions being fulfilled; or triggering a consistent LBT failure for the SL BWP or declare an SL BWP failure.

Still another embodiment of the present disclosure provides a method performed by a BS, which includes: receiving, from a UE, a first indication indicating a consistent LBT failure on a resource block (RB) set of an SL BWP; and performing one of the following: transmitting, to the UE, a second indication indicating that the RB set is recovered, or a third indication indicating that at least one of the RB set, a resource pool of the RB set, or the SL BWP is reconfigured; or receiving, from the UE, a fourth indication indicating a consistent LBT failure on each RB set of the SL BWP; and indicating another SL BWP to the UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates a method performed by a UE for handling a consistent LBT failure according to some embodiments of the present disclosure.

FIG. 3 illustrates a method performed by a BS for handling a consistent LBT failure according to some embodiments of the present disclosure.

FIG. 4 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

User equipment (UE) under NR SL-U scenario may be referred to as SL UE(s). An SL UE which transmits data on sidelink in an unlicensed spectrum may be referred to as a UE for transmitting, a transmitting UE, a transmitting SL UE, a Tx UE, an SL Tx UE, an SL BWP Tx UE, a UE, or the like. An SL UE which receives data on sidelink in an unlicensed spectrum may be referred to as a UE for receiving, a receiving UE, a receiving SL UE, an Rx UE, an SL Rx UE, a UE, or the like.

SL UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IOT) devices, personal computer (PC), game terminal, extended reality (XR) devices, or the like.

According to some embodiments of the present disclosure, SL UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present disclosure, SL UE(s) may include wearable devices, such as smart watches, fitness bands, optical head-mounted displays, or the like. Moreover, SL UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. SL UE(s) may communicate directly with BS(s) via communication signals.

A BS under NR SL-U scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

ABS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME), a serving gateway (SGW), and/or a packet data network gateway (PGW).

ABS may serve a number of SL UEs within a serving area, for example, a cell or a cell sector via a wireless communication link. A BS may communicate directly with one or more SL UEs via communication signals. For example, a BS may serve SL UEs within a macro cell.

Sidelink communication between a Tx UE and a receive (Rx) UE under NR SL-U scenario includes groupcast communication, unicast communication, or broadcast communication.

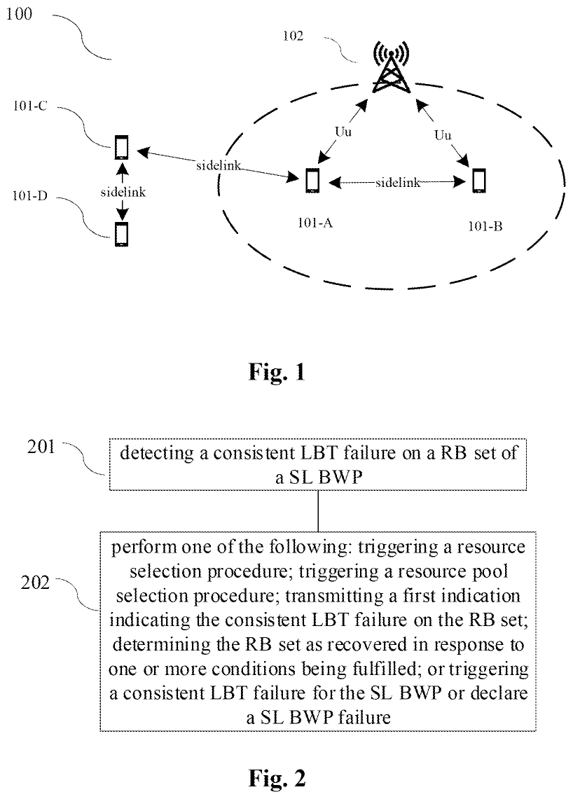

FIG. 1 illustrates a wireless communication system 100 (e.g., an SL-U communication system) in accordance with some embodiments of the present disclosure.

As shown in FIG. 1, the wireless communication system 100 includes a base station (e.g., BS 102), and some UEs (e.g., UE 101-A, UE 101-B, UE 101-C, and UE 101-D). UE 101-A and UE 101-B are within the coverage of BS 102, and UE 101-C and UE 101-D are outside the coverage of BS 102. UE 101-A, UE 101-B, UE 101-C, and UE 101-D may perform sidelink unicast transmission, sidelink groupcast transmission, or sidelink broadcast transmission in an unlicensed spectrum, such as the SL BWP. UE 101-A, UE 101-B, UE 101-C, and UE 101-D may be referred to as a SL UE. It is contemplated that, in accordance with some other embodiments of the present disclosure, a SL-U communication system may include more BSs and more or fewer SL UEs.

In addition, although the SL UEs as shown in FIG. 1 are illustrated in the shape of a cellphone, it is contemplated that a SL communication system may include any type of UE (e.g., a roadmap device, a cell phone, a computer, a laptop, IoT device or other type of device) in accordance with some other embodiments of the present disclosure.

According to some embodiments of FIG. 1, UE 101-A may function as a Tx UE, and UE 101-B, UE 101-C, and UE 101-D may function as Rx UEs. UE 101-A may exchange SL messages with UE 101-B or UE 101-C through a sidelink using, for example, the NR technology or the LTE technology, through PC5 interface as defined in 3GPP documents. UE 101-A may transmit information or data to other UE(s) within the SL-U communication system through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Alternatively, according to some other embodiments of FIG. 1, UE 101-B or UE 101-C may function as a Tx UE and transmit information or data, and UE 101-A may function as an Rx UE and receive information or data from UE 101-B or UE 101-C.

Both UE 101-A and UE 101-B in the embodiments of FIG. 1 may transmit information to BS 102 and receive control information from BS 102, for example, via a Uu interface. BS 102 may define one or more cells, and each cell may have a coverage area. As shown in FIG. 1, both UE 101-A and UE 101-B are within the coverage of BS 102, while UE 101-C and UE 101-D are not.

The BS 102 as illustrated and shown in FIG. 1 may not be a specific base station, but may be any base station(s) in the SL-U communication system. For example, assuming that the SL-U communication system includes two BSs, UE 101-A being within a coverage area of any one the two BSs may be called as a case that UE 101-A is within the coverage of a BS in the SL-U communication system; and only UE 101-A being outside of coverage area(s) of both BSs may be called as a case that UE 101-A is outside of the coverage of a BS in the SL-U communication system.

UEs may operate in different modes. At least the following two sidelink resource allocation modes are defined for sidelink communication: resource allocation mode 1: a BS may schedule a sidelink resource(s) to be used by a UE for sidelink transmission(s); and resource allocation mode 2: a UE may determine a sidelink transmission resource(s) within sidelink resources configured by a BS or network, or pre-configured sidelink resources. In resource allocation mode 2, a BS may not schedule the sidelink resources for a UE. In FIG. 1, UE 101-A and UE 101-B may be in resource allocation mode 1, and UE 101-C and UE 101-D may be in resource allocation mode 2. In some other cases, UE 101-A and UE 101-B may also operate in resource allocation mode 2. Hereinafter in the present disclosure, “mode 1” may refer to resource allocation mode 1, and “mode 2” may refer to resource allocation mode 2.

A consistent LBT failure may be detected for a BWP. For NR sidelink, only one carrier may be configured, and only one SL BWP is supported for one carrier. So per RB set based consistent LBT failure, instead of per SL BWP based consistent LBT failure, is one possible way-forward.

An SL BWP may include one or more RB sets, each RB set may include the same number of RBs, or different number of RBs based on the configuration. In some embodiments, one RB may occupy 20 MHz in the frequency domain. In some embodiments, the expression “RB set” may also be referred to as a sub-band, a sub-channel, a set of RBs, or the like. Hereinafter in the present disclosure, “an RB set,” “a sub-band,” “a sub-channel,” or “a set of RBs” may be used interchangeably where appropriate.

A counter (which may be different from the counter for a BWP) may be configured and accumulated for each received LBT failure indication for an RB set. When the value of the counter for the RB set reaches or exceeds a threshold within a time period, a consistent LBT failure is triggered on the RB set. The consistent LBT failure for an RB set may also be referred as “a per RB set consistent LBT failure,” “an RB set consistent LBT failure” or the like.

The present disclosure proposes some solutions for handling a consistent LBT failure on an RB set.

### Solution 1:

Solution 1 relates to an SL UE operating in resource allocation mode 2. In particular, a consistent LBT failure on an RB set is triggered, the UE may determine whether to trigger a resource (re)selection procedure or not. In the case that the UE determines to trigger a resource (re)selection procedure, the UE may further determine how to perform the resource (re)selection.

### Solution 1-1:

Solution 1-1 relates to a one-shot transmission, for example, a single medium access control protocol data unit (MAC PDU) transmission, the MAC PDU transmission may be configured with an initial transmission, and a number of retransmissions. In other words, the UE may first perform the initial transmission of the MAC PDU, then perform the number of retransmissions of the MAC PDU. The SL UE may have selected and reserved resources for the initial transmission and the retransmissions for an SL grant on a specific RB set. When a consistent LBT failure is triggered on the specific RB set (or the UE detects a consistent LBT failure on the specific RB set), the UE may determine the transmission status of the one-shot transmission, for example, whether the initial transmission is performed or not, or how many retransmissions are left, or the like.

In the case that no transmission of the one-shot transmission has been performed, that is, none of the initial transmission or the number of retransmissions has been performed, and the SL UE still needs to transmit the one-shot transmission, the SL UE may be triggered to perform a resource selection procedure (or a resource reselection procedure). The SL UE may clear the SL grant and remove all reserved resource(s) (because no transmissions have been performed), and trigger a resource (re)selection procedure to select new resources for the initial transmission and the number of retransmissions.

In the case that at least one transmission of the one-shot transmission has been performed, the at least one of transmission among the initial transmission and the number of retransmissions have been performed. Accordingly, the initial transmission of the one-shot transmission has been performed, and there might be some retransmissions of the one-shot transmission that have not been performed. In the case that the SL UE still needs to perform the retransmissions of the one-shot transmission, the SL UE may be triggered to perform a resource selection procedure (or a resource reselection procedure). The SL UE may clear the SL grant and remove the remaining reserved resource(s) (which is reserved for performing the remaining retransmissions of the MAC PDU), and trigger a resource (re)selection procedure to select a new resource(s) for the remaining retransmissions.

In the case that all transmissions of the one-shot transmission have been performed, there might be no need to trigger a resource selection procedure (or a resource reselection procedure).

In some embodiments, an SL UE may have selected three resources for a specific SL grant to perform a single MAC PDU transmission, in which one resource is for the initial transmission of the single MAC PDU transmission, and two resources are for the retransmissions of the single MAC PDU transmission. The SL UE may detect a consistent LBT failure is triggered for the RB set after the initial transmission of the single MAC PDU transmission, and the SL UE may clear the SL grant and remove two resources for retransmissions of the single MAC PDU transmission. In the case that the SL UE still needs to perform the rest of the single MAC PDU transmission, that is, perform the two retransmissions of the single MAC PDU transmission, the UE may trigger a resource selection procedure (or a resource reselection procedure) to select two new resources for the two retransmissions of the single MAC PDU transmission on an RB set with no consistent LBT failure.

### Solution 1-2:

Solution 1-2 relates to a multi-shot transmission, for example, transmissions of multiple MAC PDUs. The transmissions of multiple MAC PDUs may be transmitted periodically, and the SL UE may have selected and reserved a series of resources for the periodic transmissions of the multiple MAC PDUs for an SL grant on a specific RB set. When a consistent LBT failure is triggered on the specific RB set, the UE may determine the transmission status of the multi-shot transmission, for example, or how many retransmissions are left, or the like.

When a number of transmissions of the multiple MAC PDUs have not been performed (the number may range from 0 to the total number of the transmissions of the multiple MAC PDUs), and the SL UE still needs to perform a/the number of transmissions of the multiple MAC PDUs, the SL UE may be triggered to perform a resource selection procedure (or a resource reselection procedure). That is, the SL UE may clear the SL grant and remove the remaining reserved resource(s) (the number of the remaining reserved resource(s) may range from 0 to the total number of the transmissions of the multiple MAC PDUs), and trigger a resource (re)selection to select a new resource(s) for the number of transmissions of the multiple MAC PDUs on an RB set with no consistent LBT failure.

For example, an SL UE may have selected and reserved 30 resources on an RB set for a specific SL grant to perform the multi-shot transmission, and a consistent LBT failure may have occurred for the RB set after the 10^{th} transmission, in other words, when the first ten transmissions are performed, the SL UE may clear the SL grant and remove the remaining 20 resources for the multi-shot transmission, and trigger a resource (re)selection to select 20 new resources for the remaining 20 transmissions of the multi-shot transmission on RB set with no consistent LBT failure.

In the case that all transmissions of the multi-shot transmission have been performed, there might be no need to trigger a resource selection procedure (or a resource reselection procedure).

### Solution 1-3:

Solution 1-3 relates to a transmission associated with a specific Layer 2 (L2) destination, or a specific LCH, or an LCH with a specific priority level.

In some embodiments, the reselected resources for the SL transmissions are only enabled for data of a specific Layer 2 (L2) destination, or a specific LCH, or an LCH with a specific priority level.

For example, in the case that one-shot transmission is associated with a specific LCH, and at least one transmission of the initial transmission and the number of retransmissions of the one-shot transmission has not been performed, the SL UE may trigger a resource selection procedure or a resource reselection procedure, to perform the rest of the transmission(s) of the initial transmission and the number of retransmissions of the one-shot transmission. In another example, in the case that multi-shot transmission is for a specific L2 destination, and at least one transmission of the multi-shot transmission has not been performed, the SL UE may trigger a resource selection procedure or a resource reselection procedure, to perform the rest of the transmission(s) of the multi-shot transmission. In another example, in the case that any SL transmission is associated with an LCH with a specific priority level, and a consistent LBT failure occurs on an RB set, when a consistent LBT failure is triggered on the specific RB set, the UE may trigger a resource selection procedure or a resource reselection procedure, to perform the rest of the SL transmission.

During the resource (re)selection procedure to select a new resource(s), the SL UE may be prohibited from selecting a resource(s) on an RB set where a consistent LBT failure has occurred on the RB set, until the RB set is recovered. That is to say, UE may only select a resource(s) on an RB set with no consistent LBT failure.

### Solution 2

Solution 2 relates to an SL UE operating in resource allocation mode 2. The SL UE may perform a resource pool selection procedure when a consistent failure on an RB set is triggered (or when the UE detects a consistent LBT failure on the specific RB set). An RB set with a consistent failure may be referred to as “a problematic RB set”, “an RB set with lower priority level,” or the like.

In some embodiments, during a resource pool selection procedure, several rules may be applied:
Rule 1: in the case that a resource pool includes only one RB set, which is a problematic RB set, the resource pool may be prohibited from being selected, until the RB set in the resource pool is recovered, or until the RB set is available. In the case that a resource pool includes two or more RB sets, and all the RB sets in the resource pool are problematic RB sets, the resource pool may be prohibited from being selected.
Rule 2: a resource pool may include another RB set(s) in addition to a problematic RB set(s), in other words, one or more RB set(s) in the resource pool are not problematic, and in this case, the resource pool may be prohibited from being selected.

Alternatively, the resource pool may be determined to be associated with a lower priority level compared with another resource pool with no problematic RB set. For example, a resource pool with no problematic RB set(s) may have a higher priority level, for example, “0”; a resource pool with both problematic RB set(s) and a normal RB set(s) (i.e., RB set(s) with no consistent LBT failure) may have a lower priority level, for example, “1”. In some cases, the resource pool with both a problematic RB set(s) and a normal RB set(s) may be labeled with “problem”, and considered as a problematic resource pool; while the resource pool with no problematic RB set(s) may not be labeled.

During a resource pool selection procedure, the SL UE may prefer a resource pool with a higher priority level (such as “0”) over the resource pool with a lower priority level (such as “1”). In the case that no resource pool with a higher priority level has been selected, the SL UE may then select a resource pool with a lower priority level.

Within the resource pool with a lower priority level (i.e., a problematic resource pool), the RB set(s) with a consistent LBT failure may be labeled as a problem, that is, the RB set(s) may be considered as a problematic RB set(s), and may be determined to be associated with a lower priority level (such as “low”) compared with another RB set(s) with no consistent LBT failure (such as “high”) in the problematic resource pool. Accordingly, when the SL UE selects a resource pool with a lower priority level, the SL UE may select an RB set with a higher priority level (such as “high”) in the resource pool.

### Solution 3

Solution 3 relates to an SL UE operating in resource allocation mode 1. For a UE in mode 1, such as UE 101-A in FIG. 1, when a consistent LBT failure for a specific RB set is triggered, the SL UE may transmit an indication to the BS, or to the network, to indicate the consistent LBT failure on the RB set. The indication may be a MAC CE, or RRC signalling, and the indication may be transmitted on the Uu interface between the BS and the UE.

In some embodiments, the indication may include the consistent LBT failure information and the corresponding RB set(s), for example, the number of LBT failure indications, the identifier of the RB set(s), or the like.

In some embodiments, the SL UE may receive an indication from a peer UE, for example, another SL UE, which may include a consistent LBT failure report. The consistent LBT failure report from the peer UE may include the number of LBT failure indications, the identifier of the RB set(s), or the like. The peer UE may either operate in resource allocation mode 1 or in resource allocation mode 2. After receiving the indication, the SL UE may be triggered to transmit a report to the BS about the consistent LBT failure information and corresponding RB set(s) of the peer UE.

Since the BS may schedule a sidelink resource(s) to be used by a UE in resource allocation mode 1 for sidelink transmission(s), after receiving the indication (or report) from the UE, the BS may indicate the UE to use another sidelink resource(s).

### Solution 4:

Solution 4 relates to recovery from a consistent LBT failure on an RB set, and relates to an SL UE operating in resource allocation mode 1 or mode 2.

### Solution 4-1:

Solution 4-1 relates to an SL UE operating in resource allocation mode 1 or resource allocation mode 2. When a consistent LBT failure is triggered for a specific RB set, the SL UE may start a timer, which may be referred to as a prohibit timer. The length of the timer may be indicated by the network, for example, via an indication from the BS, or may be preconfigured, or configured.

When the timer is running, i.e., during the time period of the timer, the SL UE may be prohibited from selecting the specific RB set during a resource selection procedure or a resource reselection procedure. The resources in the specific RB set are prohibited from being used for SL communication. When the timer expires, the SL UE may consider that the specific RB set is recovered, i.e., the specific RB set may be selected by the SL UE during a resource selection procedure or a resource reselection procedure, or may be used for SL communication. The specific RB set may also be referred to as available when the timer expires.

### Solution 4-2

Solution 4-2 relates to an SL UE operating in resource allocation mode 1 or resource allocation mode 2. When a consistent LBT failure is triggered for a specific RB set, the SL UE may perform an LBT procedure on the RB set continuously. For example, the SL UE may perform an LBT procedure on the RB set in a periodical manner. The LBT procedure may be any type of LBT procedure, for example, LBT type 1, LBT type 2 a, LBT type b, LBT category 1 (Cat. 1), LBT Cat. 2, LBT Cat. 4, etc. The periodicity for performing the LBT procedure may be indicated by the BS, by the network, or may be configured or preconfigured.

In some embodiments, a first threshold and a time period may be used to determine whether the RB set is recovered or not. The first threshold may be associated with an accumulated LBT success number. The value of the first threshold and/or the time period may be indicated by the BS, by the network, or may be configured or preconfigured. In the case that during the time period, the accumulated LBT success number is larger than the first threshold, the RB set is regarded as recovered, or as available, and may be used for SL transmission.

In some embodiments, a second threshold and a time period may be used to determine whether the RB set is recovered or not. The second threshold may be associated with an accumulated LBT failure number. The value of the second threshold and/or the time period may be indicated by the BS, by the network, or may be configured or preconfigured. In the case that during the time period, the accumulated LBT failure number is smaller than the second threshold, the RB set is considered as recovered, or as available, and may be used for SL transmission.

Solution 4-3Solution 4-3 relates to an SL UE operating in resource allocation mode 1 or resource allocation mode 2. When a consistent LBT failure is triggered for a specific RB set, the SL UE may perform a CBR measurement on the specific RB set continuously, such as in a periodical manner. A threshold associated with the CBR measurement may be indicated by the BS, by the network, or may be configured or preconfigured. When a CBR measurement result is lower than the threshold, i.e., the load of the specific RB set is lower than the threshold, the RB set is considered as recovered, or as available, and may be used for SL transmission.

### Solution 4-4

Solution 4-4 relates to an SL UE operating in resource allocation mode 1. When a consistent LBT failure is triggered for a specific RB set, the SL UE in mode 1 may receive an indication from the BS, which may indicate that the specific RB set is recovered or available. The UE then may consider the specific RB set as recovered or available. The BS may determine whether the specific RB set is recovered or available by collecting other SL-U UE transmission information on the specific RB set.

### Solution 4-5

Solution 4-5 relates to an SL UE operating in resource allocation mode 1. When a consistent LBT failure is triggered for a specific RB set, the SL UE in mode 1 may receive an indication from the BS, which may indicate at least one of the following:
a) the specific RB set is reconfigured;
b) a resource pool including the specific RB set is reconfigured; or
c) an LBT sub-channel (or LBT BWP) including the specific RB set is reconfigured.

Based on this indication, the UE may consider that the specific RB set as recovered or available.

When an RB set is recovered, in the case that the UE may have labeled the specific RB set as problematic, or determined that the RB set is associated with a lower priority level (such as “low”), after the specific RB set is recovered, the UE may remove the problematic label, or determine that the RB set is associated with a higher priority level (such as “high”).

Similarly, when a resource pool is recovered, in the case that the UE may have labeled the resource pool as problematic, or determined that the resource pool is associated with a lower priority level (such as “1”) compared with other resource pools, after the resource pool is recovered, the UE may remove the problematic label, or determine that the resource pool is associated with a higher priority level (such as “0”).

### Solution 5:

Solution 5 relates to an SL UE operating in resource allocation mode 1.

In some embodiments, for each RB set of all RB sets of the SL BWP, a consistent LBT failure is triggered.

In this case, the UE may trigger a consistent LBT failure for the SL BWP. Alternatively, the UE may declare an SL BWP failure, that is, the UE may consider that the SL BWP cannot be used anymore.

In one embodiment, if a consistent LBT failure is triggered for all RB sets on a configured SL-BWP or SL carrier, in one option, a consistent LBT failure for the configured SL BWP is triggered. In another option, if a consistent LBT failure is triggered for all RB sets on the configured SL-BWP or SL carrier, the UE may declare the SL carrier is a failure, i.e., the SL carrier cannot be used anymore. The UE may report to higher layers, and report to the BS to require a new SL carrier for SL communication.

FIG. 2 illustrates a method performed by a UE for handling a consistent LBT failure according to some embodiments of the present disclosure.

In operation 201, the UE may detect a consistent LBT failure on an RB set of an SL BWP. In operation 202, the UE may perform one of the following: triggering a resource selection procedure; triggering a resource pool selection procedure; transmitting a first indication indicating the consistent LBT failure on the RB set; determining the RB set as recovered in response to one or more conditions being fulfilled; or triggering a consistent LBT failure for the SL BWP or declare an SL BWP failure.

In some embodiments, the resource selection procedure may include at least one of the following: performing a resource selection procedure for remaining transmission(s) on an RB set with no consistent LBT failure for a one-shot transmission; performing a resource selection procedure for reserved resource(s) on the RB set with no consistent LBT failure for a multi-shot transmission; or performing a resource selection procedure for remaining transmission(s) on the RB set with no consistent LBT failure, wherein the remaining transmission(s) is associated with at least one of: a specific destination, a specific LCH, or an LCH with a specific priority level. For example, the UE may perform a resource selection procedure for remaining transmissions (or remaining retransmissions) for a single MAC PDU transmission, and the UE may perform the resource selection procedure on an RB set with no consistent LBT failure. Similarly, the UE may perform a resource selection procedure for remaining transmissions of a multiple MAC PDU transmissions (i.e., periodical MAC PDU transmissions) on an RB set with no consistent LBT failure. In some embodiments, when the single MAC PDU transmission, or the multiple MAC PDU transmissions is associated with a specific priority level, such as higher than a priority threshold, the UE may performing a resource selection procedure for remaining transmission(s)

In some embodiments, the resource pool selection procedure includes one of the following: prohibiting selection of a resource pool including the RB set; or selecting the resource pool including the RB set in the case that no other resource pool is available and the resource pool includes other RB sets with no consistent LBT failure.

In some embodiments, the resource pool including the RB set is determined with a lower priority level compared with other resource pool(s) with no consistent LBT failure on any RB set in the other resource pool(s).

In some embodiments, the RB set in the resource pool is determined with a lower priority level compared with other RB set(s) in the resource pool.

In some embodiments, the first indication includes a MAC CE or RRC signalling.

In some embodiments, the one or more conditions include: a prohibit timer being expired (for example, solution 4-1); an LBT success number associated with the RB set being higher than a first threshold (for example, solution 4-2); an LBT failure number associated with the RB set being lower than a second threshold (for example, solution 4-2); a result of a CBR measurement on that RB set being lower than a third threshold (for example, solution 4-3); a second indication from the BS indicating that the RB set is recovered (for example, solution 4-4); a third indication from the BS indicating that at least one of the RB set, a resource pool of the RB set, or the SL BWP is reconfigured (for example, solution 4-5).

In some embodiments, in the case that a consistent LBT failure on each RB set of the SL BWP is detected, the processor is further configured to: trigger a consistent LBT failure for the SL BWP; or declare an SL BWP failure.

In some embodiments, the UE may transmit a fourth indication indicating the consistent LBT failure for the SL BWP.

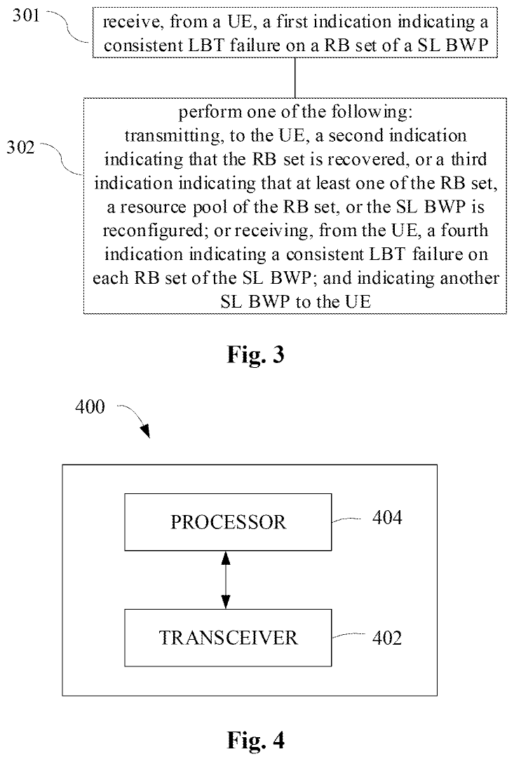

FIG. 3 illustrates a method performed by a BS for handling a consistent LBT failure according to some embodiments of the present disclosure.

In operation 301, the BS may receive, from a UE, a first indication indicating a consistent LBT failure on an RB set of an SL BWP; and perform one of the following: transmitting, to the UE, a second indication indicating that the RB set is recovered, or a third indication indicating that at least one of the RB set, a resource pool of the RB set, or the SL BWP is reconfigured; or receiving, from the UE, a fourth indication indicating a consistent LBT failure on each RB set of the SL BWP; and the indicating another SL BWP to the UE.

FIG. 4 illustrates a simplified block diagram of an exemplary apparatus according to some embodiments of the present disclosure.

As shown in FIG. 4, an example of the apparatus 400 may include at least one processor 404 and at least one transceiver 402 coupled to the processor 404. The apparatus 400 may be a UE, a BS, a RAN node, a source node, a target node, a third node, or any other device with similar functions.

Although in this figure, elements such as the at least one transceiver 402 and processor 404 are described in the singular, the plural is contemplated unless a limitation to the singular is explicitly stated. In some embodiments of the present disclosure, the transceiver 402 may be divided into two devices, such as a receiving circuitry and a transmitting circuitry. In some embodiments of the present disclosure, the apparatus 400 may further include an input device, a memory, and/or other components.

In some embodiments of the present disclosure, the apparatus 400 may be a UE. The transceiver 402 and the processor 404 may interact with each other so as to perform the operations of the UE described in any of FIGS. 1-4. In some embodiments of the present disclosure, the apparatus 400 may be a node. The transceiver 402 and the processor 404 may interact with each other so as to perform the operations of the node described in any of FIGS. 1-3.

In some embodiments of the present disclosure, the apparatus 400 may further include at least one non-transitory computer-readable medium.

For example, in some embodiments of the present disclosure, the non-transitory computer-readable medium may have stored thereon computer-executable instructions to cause the processor 404 to implement the method with respect to the UE as described above. For example, the computer-executable instructions, when executed, cause the processor 404 interacting with transceiver 402 to perform the operations of the UE described in any of FIGS. 1-3.

In some embodiments of the present disclosure, the non-transitory computer-readable medium may have stored thereon computer-executable instructions to cause the processor 404 to implement the method with respect to the node as described above. For example, the computer-executable instructions, when executed, cause the processor 404 interacting with transceiver 402 to perform the operations of the node described in any of FIGS. 1-3.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
detect a consistent listen before talk (LBT) failure on a resource block (RB) set of a sidelink (SL) bandwidth part (BWP); and
trigger a resource selection procedure;
trigger a resource pool selection procedure;
transmit a first indication indicating the consistent LBT failure on the RB set; or
determine the RB set as recovered in response to one or more conditions being fulfilled.

2. The UE of claim 1, wherein the resource selection procedure includes:
performing a resource selection procedure for a one-shot transmission;
performing a resource selection procedure for reserved resource(s) for a multi-shot transmission; or
performing a resource selection procedure on the RB set with no consistent LBT failure.

3. The UE of claim 1, wherein the resource pool selection procedure includes:
prohibiting selection of a resource pool including the RB set; or
selecting the resource pool including the RB set in the case that no other resource pool is available and the resource pool includes other RB sets with no consistent LBT failure.

4. The UE of claim 3, wherein the resource pool including the RB set is determined with a lower priority level compared with other resource pools with no consistent LBT failure on any RB set in the other resource pools.

5. The UE of claim 4, wherein the RB set in the resource pool is determined with a lower priority level compared with other RB sets in the resource pool.

6. The UE of claim 1, wherein the first indication includes a media access control control element (MAC CE).

7. The UE of claim 1, wherein the one or more conditions include:
a prohibit timer being expired;
an LBT success number associated with the RB set being higher than a first threshold;
an LBT failure number associated with the RB set being lower than a second threshold;
a result of a channel busy ratio (CBR) measurement on that RB set being lower than a third threshold;
a second indication from the BS indicating that the RB set is recovered; or
a third indication from the BS indicating that at least one of the RB set, a resource pool of the RB set, or the SL BWP is reconfigured.

8. The UE of claim 1, wherein, when a consistent LBT failure on each RB set of the SL BWP is detected, the at least one processor is further configured to cause the UE to:
trigger a consistent LBT failure for the SL BWP; or
declare a SL BWP failure.

9. The UE of claim 8, wherein the at least one processor is further configured to cause the UE to:
transmit a fourth indication indicating the consistent LBT failure for the SL BWP.

10. A base station (BS) for wireless communication, comprising:
at least one memory; and
at least one processor coupled with the at least one memory and configured to cause the BS to:
receive, from a user equipment (UE), a first indication indicating a consistent listen before talk (LBT) failure on a resource block (RB) set of a sidelink (SL) bandwidth part (BWP); and
transmit, to the UE, a second indication indicating that the RB set is recovered, or a third indication indicating that at least one of the RB set, a resource pool of the RB set, or the SL BWP is reconfigured; or
receive, from the UE, a fourth indication indicating a consistent LBT failure on each RB set of the SL BWP; and indicating another SL BWP to the UE.

11. The BS of claim 10, wherein the first indication includes a media access control control element (MAC CE).

12. A method performed by a user equipment (UE), the method comprising:
detecting a consistent listen before talk (LBT) failure on a resource block (RB) set of a sidelink (SL) bandwidth part (BWP); and
triggering a resource selection procedure;
triggering a resource pool selection procedure;
transmitting a first indication indicating the consistent LBT failure on the RB set; or
determining the RB set as recovered in response to one or more conditions being fulfilled.

13. The method of claim 12, further comprising:
performing a resource selection procedure for a for a one-shot transmission;
performing a resource selection procedure for reserved resources for a multi-shot transmission; or
performing a resource selection procedure on the RB set with no consistent LBT failure.

14. The method of claim 12, further comprising:
prohibiting selection of a resource pool including the RB set; or
selecting the resource pool including the RB set in the case that no other resource pool is available and the resource pool includes other RB sets with no consistent LBT failure.

15. (canceled)

16. The method of claim 12, wherein the one or more conditions include a prohibit timer being expired.

17. The method of claim 12, wherein the first indication includes a media access control control element (MAC CE).

18. A processor for wireless communication, comprising:
at least one controller coupled with the at least one memory and configured to cause the processor to:
detect a consistent listen before talk (LBT) failure on a resource block (RB) set of a sidelink (SL) bandwidth part (BWP); and
trigger a resource selection procedure;
trigger a resource pool selection procedure;
transmit a first indication indicating the consistent LBT failure on the RB set; or
determine the RB set as recovered in response to one or more conditions being fulfilled.

19. The processor of claim 18, wherein the resource selection procedure includes:
performing a resource selection procedure for a one-shot transmission;
performing a resource selection procedure for reserved resources for a multi-shot transmission; or
performing a resource selection procedure on the RB set with no consistent LBT failure.

20. The processor of claim 18, wherein the resource pool selection procedure includes:
prohibiting selection of a resource pool including the RB set; or
selecting the resource pool including the RB set in the case that no other resource pool is available and the resource pool includes other RB sets with no consistent LBT failure.

21. The processor of claim 18, wherein the one or more conditions include a prohibit timer being expired.
